(19) United States
(12) Patent Application Publication
(10) Pub. No.: US 2017/0300873 A1
(43) Pub. Date: Oct. 19, 2017

(54) SYSTEM AND METHOD FOR SECURE AUTOMATED CLEARINGHOUSE TRANSACTIONS

(71) Applicant: MINERALTREE, INC., Cambridge, MA (US)

(72) Inventor: Bagepalli C. Krishna, Cambridge, MA (US)

(21) Appl. No.: 15/488,772

(22) Filed: Apr. 17, 2017

Related U.S. Application Data
(60) Provisional application No. 62/323,147, filed on Apr. 15, 2016.

(51) Int. Cl. G06Q 20/02; G06Q 20/40; G06Q 20/22

(52) U.S. Cl. CPC G06Q 20/023; G06Q 20/223; G06Q 20/405

(57) ABSTRACT

An electronic clearinghouse system includes a first payment agent associated with a payer institution and configured to transmit a request for secure payee account information, and further configured to initiate a payment over a payment network from the payer institution to a payee using the secure payee account information; and a second payment agent associated with a payee institution that is associated with a payee identified by the secure payee account information, the second payment agent configured to receive, from the first payment agent, the request for the secure payee account information, and further configured to transmit the secure payee account information to the first payment agent.

### CROSS REFERENCE TO RELATED APPLICATIONS

This application claims priority under 35 U.S.C. §119(e) to U.S. Provisional Application Ser. No. 62/323,147, titled “SYSTEM AND METHOD FOR SECURE AUTOMATED CLEARINGHOUSE TRANSACTIONS,” filed Apr. 15, 2016, which is incorporated herein by reference in its entirety.

### BACKGROUND

### Technical Field

The technical field of this disclosure relates generally to payment networks and, more specifically, to measures for controlling access to account information for accounts on such payment networks.

### Discussion

Electronic transactions have become the norm in the banking/financial industry. Money can be moved between accounts at the same or different institutions, and can be carried out by individually occurring transactions or transactions processed in large batches, typically during non-business hours. The transactions may include credit or debit transactions, may include recurring or one-time payments, and may involve parties such as individuals, businesses, and governmental entities.

Distributed payment networks, such as clearinghouse systems, allow users to pay others by initiating a payment via the network. The request to make a payment includes, among other information, the payee's account information and routing information for the payee's financial institution.

One such payment network is the automated clearinghouse (ACH) network in the United States. The ACH network supports ACH credit and debit transactions. The ACH network continues to grow at a rapid rate, to the point it is nearly ubiquitous; each year it moves more than $41 trillion and 24 billion electronic financial transactions. Government and businesses use ACH for payroll, tax payments, and expense reimbursements, and have begun expanding its use to other types of transactions, such as Accounts Payable. The ACH network processes large volumes of credit and debit transactions in batches—currently overnight, yet same-day ACH is on the horizon. ACH is well on its way to becoming the de facto electronic payment channel.

An exemplary payment system 100 (e.g., an ACH payment system) as currently known is seen in FIG. 1. In this simplified example, an owner of a payer account 112 (i.e., a payer) at a payer institution 110 may wish to make a payment to a payee account 132 (associated with a payee) at a payee institution 130 via the payment network 150. To do so, the payer submits a request that includes the payee's account information and bank routing information, as well as other information about the transaction, such as the amount of currency to be transferred, and the payer's account information. When the transaction is processed, the payer account 112 at payer institution 110 is debited, and the payee account 132 at the payee institution 130 is credited. System 100 is shown in a simplified manner, with only two institutions. Yet hundreds or thousands of institutions may process transactions over the payment network 150, with any institution able (at least in theory) to be either a payer or payee in any given transaction.

As can be seen, the payer must have the payee's account information and bank routing information (referred to collectively herein as “secure payee account information”) in order to initiate a transfer. This aspect of ACH introduces certain security considerations. Account and routing information is highly sensitive, in that it may be used to initiate fraudulent transactions involving the payee's account. For example, the would-be payer may instead use the secure payee account information to request a payment from the payee account 132, which unauthorized withdrawal may or may not be discovered by the owner of the payee account 132.

Even legitimate payers must ensure that the secure payee account information is used only for authorized purposes, and does not fall into the hands of third parties or employees with no reason to access the information. The secure payee account information is therefore a potential liability to all involved: the payee and/or payee institution 130, whose account is vulnerable to fraud; and the payer and/or payer institution 110, who must incur the cost, in time and money, of enacting safeguards and procedures to keep the secure payee account information secure.

### SUMMARY

Aspects and embodiments of the present disclosure address these drawbacks of payment networks by eliminating the need to provide a payer or others with the secure payee account information. Instead, the payee may publish or otherwise make freely available a token (e.g., an alphanumeric string) that uniquely identifies the payee and the payee's financial institution (e.g., bank) where the payee's account to receive the funds is located. The token does not, however, contain or reveal the secure payee account information.

To initiate a payment, the payer provides the token to a first payment agent at the payer's own financial institution. The first payment agent may use the information provided in the token to identify which of a number of second payment agents is associated with the payee institution, such as by comparing the token (or a portion thereof) to a token database that associates the token with a payment agent.

Using the token, the first payment agent communicates securely with the secure (and trusted) second payment agent at the payee's financial institution to request the payee's sensitive account information. The second payment agent then transmits the secure payee account information to the first payment agent. The secure payee information may be sent, for example, over a secure peer-to-peer channel established directly between the first payment agent and the second payment agent.

The first payment agent then provides the secure payee information to the payee institution to be used in processing the payment from the payer to the payee in the normal manner over the payment network. At no time, however, need the payer be provided with the secure payee account information. In one example, the first payment agent generates a transaction file—such as a file in the industry-standard National Automated Clearinghouse Association (NACHA) format—using the payment amount and other details provided by the payer, the payee account information provided by the second payment agent, and other information. The NACHA file can be presented to the payer's bank, and the transaction processed like any other ACH transfer.

Use of a distributed, secure network of payment agents to share secure payee account information provides a number of improvements over currently available technologies. First, as noted above, the payer is never provided with the secure payee account information, thereby reducing the risk of the information being used maliciously. Second, because the aspects disclosed herein are layered on the existing (e.g., ACH) infrastructure, no changes to the existing payment network are necessary. The current approach therefore provides the advantage of using an existing payment network, while not requiring that sensitive information be shared in order to use that payment network, thereby overcoming a drawback of current solutions.

According to one aspect, an electronic clearinghouse system is provided. The system includes a first payment agent associated with a payer institution and configured to transmit a request for secure payee account information, and further configured to initiate a payment over a payment network from the payer institution to a payee using the secure payee account information; and a second payment agent associated with the payee institution that is associated with a payee identified by the secure payee account information, the second payment agent configured to receive, from the first payment agent, the request for the secure payee account information, and further configured to transmit the secure payee account information to the first payment agent.

According to one embodiment, the request includes a token identifying at least one of the payee and the payee institution. According to a further embodiment, the first payment agent is further configured to identify, from the token, the second payment agent from a plurality of second payment agents, and to transmit the request for the secure payee account information to the second payment agent. According to another, further embodiment, the token includes a payee identifier, and the second payment agent further includes a payee database that associates the payee identifier with the secure payee account information.

According to another embodiment, the payment network is an automated clearinghouse (ACH) network. According to a further embodiment, the first payment agent is further configured to generate, based on the secure payee account information, a file in a national automated clearinghouse association (NACHA) file format; and provide the file to the payer institution.

According to yet another embodiment, the first payment agent is executed on a first server, and the second payment agent is executed on a second server, wherein the first server and the second server are configured to communicate via a secure communication channel. According to another embodiment, the second payment agent is configured to transmit the secure payee account information to the first payment agent responsive to determining that the first payment agent is authorized to receive the secure payee account information.

According to another embodiment, each of the first payment agent and the second payment agent further includes a network interface in communication with a network through which the first payment agent and the second payment agent are communicatively coupled. According to a further embodiment, the network is a peer-to-peer network over which the first payment agent and the second payment agent are configured to communicate with each other.

According to another embodiment, the first payment agent further includes a transaction interface, and the first payment agent is further configured to initiate the payment via the transaction interface using the secure payee account information.

According to another aspect, a method of processing payments is provided. The method includes receiving, at a first payment agent associated with a payer institution in a payment network, a first request from a payer to initiate a payment to a payee over the payment network; transmitting, to a second payment agent associated with a payee institution in the payment network, a second request for secure payee account information; receiving, from the second payment agent, the secure payee account information; and providing to the payer institution an instruction to initiate the payment to the payee, the instruction comprising the secure payee account information.

According to one embodiment, the first request includes a token including at least one of a payee identifier and a payee institution identifier. According to another embodiment, the secure payee account information includes an account number of the payee at the payee institution. According to yet another embodiment, the secure payee account information includes a routing number of the payee institution.

According to one embodiment, the payment network is an automated clearinghouse (ACH) network. According to a further embodiment, the instruction to initiate the payment to the payee includes an instruction to perform an ACH push. According to another, further embodiment, the method further includes generating by the first payment agent, based on the secure payee account information, a file in a national automated clearinghouse association (NACHA) file format; and transmitting the file to the payer institution.

According to one embodiment, the first request includes a payment amount. According to another embodiment, the first payment agent and the second payment agent are configured to communicate via a peer-to-peer network. According to yet another embodiment, the first payment agent is further configured to identify, from the request, the second payment agent from a plurality of second payment agents.

Still other aspects, embodiments and advantages of these example aspects and embodiments, are discussed in detail below. Moreover, it is to be understood that both the foregoing information and the following detailed description are merely illustrative examples of various aspects and embodiments, and are intended to provide an overview or framework for understanding the nature and character of the claimed aspects and embodiments. Any embodiment disclosed herein may be combined with any other embodiment. References to “an embodiment,” “an example,” “some embodiments,” “some examples,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. The appearances of such terms herein are not necessarily all referring to the same embodiment.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a current payment system;

FIG. 2 is a block diagram of a payment system according to one embodiment;

FIG. 3 is a block diagram of components of a payment system according to one embodiment;

FIG. 4 illustrates an exemplary token communicated among payment agents according to one embodiment;

FIG. 5 illustrates a flow of information between system components according to one embodiment;

FIG. 6 is a flow chart of a method for processing payments according to one embodiment; and

FIG. 7 is a block diagram of one example of a computer system on which aspects and embodiments of this disclosure may be implemented.

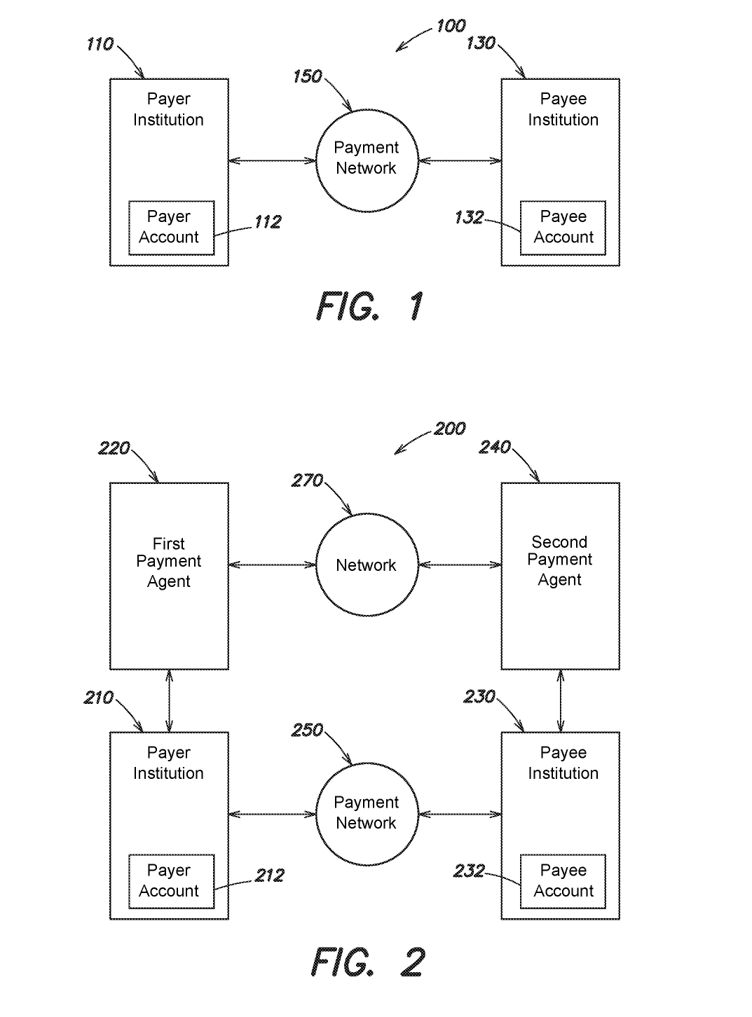

### DETAILED DESCRIPTION

Embodiments of the present invention relate to systems and methods for securely providing sensitive account information between payment agents, the information being used to initiate transactions in a distributed payment system, such as an ACH clearinghouse system. In an exemplary system, a first payment agent is associated with a payer institution, and a second payment agent is associated with a payee institution. The first payment agent is configured to send a token to the second payment agent via a network, the token containing information that uniquely identifies, for the second payment agent, an account at the payee institution. The token does not, however, contain “actionable” information that could be used by others, such as the actual account number or other identifier. In response, the second payment agent is configured to send to the first payment agent secure payee account information (e.g., account number and institution routing number) corresponding to the account identified by the token. The first payment agent is then configured to use this information to initiate a transfer from a payer account at the payer institution to the payee account at the payee institution. The transfer is performed using known systems, such as the ACH network, without requiring the payee to provide secure payee account information.

The first payment agent and the second payment agent may be instances of a software program configured to communicate securely with other instances of itself over a network, such as the Internet. The payment agents may be physically and/or logically associated with their respective institutions. For example, a payment agent may run on a computer (e.g., a server) physically located on the premises of the institution. In another example, the payment agent may run on a computer located remotely from the institution (such as at a facility operated by an offeror of the payment agent, or in a scalable cloud computing facility or server farm), and may be in communication with computers at or associated with the institution.

In some embodiments, a payment agent may be used in connection with more than one institution, or more than one branch of an institution. For example, all of the branches of a particular institution may use a single payment agent, or a number of affiliated or networked institutions may use a single payment agent.

In some embodiments, while the payment agent associated with a payee institution may be fixed, a request from a payer may be directed to any one of a number of payment agents, which may be dynamically determined based on load balancing, network proximity, or other considerations. In such embodiments, the payer may provide the designated payment agent with the payer's own account and routing information, or other information necessary for transferring funds out of the payer's account. The designated payment agent may then contact the payer institution (or another payment associated therewith) to initiate the transfer after requesting and obtaining the secure payee account information from the second payment agent in the manner described herein.

References to a “first” and “second” payment agent, and to a payer and payee institution, are for ease of illustration. It will be appreciated that, for any given transaction, an institution may be either a payer or payee institution, and any payment agent may be the first payment agent or the second payment agent as described herein. In other words, all descriptions of the role and functionality of the payer institution and first payment agent should be understood as equally applicable to the payee institution and the second payment agent, respectively.

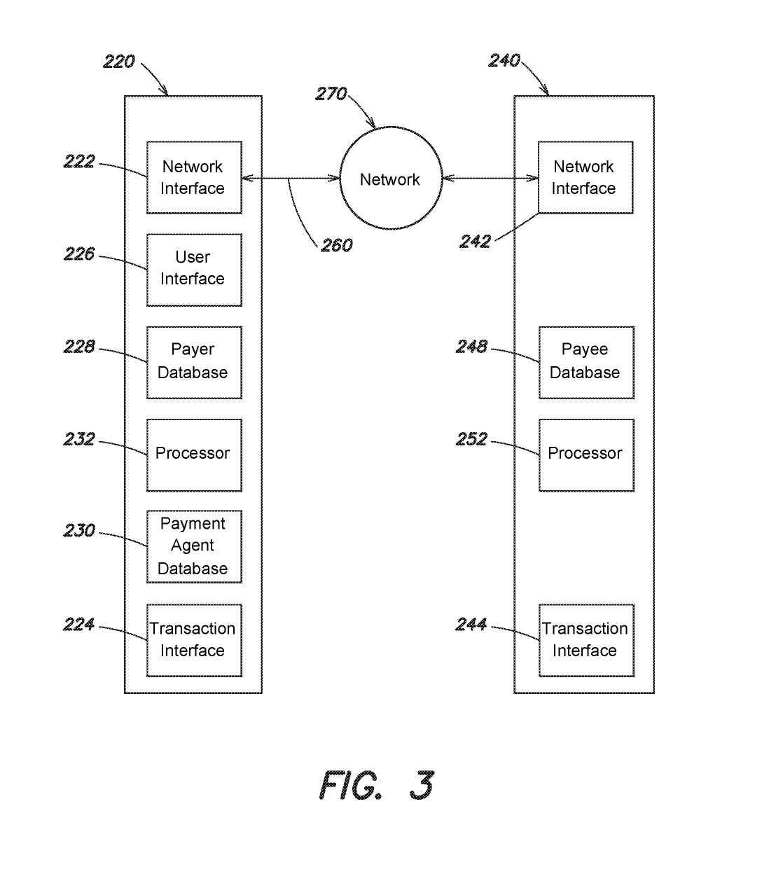

An exemplary system 200 is shown in FIG. 2. With respect to an exemplary transaction, a first payment agent 220 is associated with and in communication with a payer institution 210 at which a payer account 212 is maintained by a payer. Similarly, a payment agent 240 is associated with a payee institution 230 at which a payee account 232 is maintained by a payee. The payer institution 210 and the payee institution 230 are each connected, directly or indirectly, to a payment network 250, shown here for purposes of illustration as an ACH network. For example, the payer institution 210 and the payee institution 230 may maintain or otherwise have access to ACH terminals configured to initiate and carry out ACH transactions.

The first payment agent 220 and the second payment agent 240 are configured to communicate with each other via a network 270, such as the Internet. A secure communication format may be used, such as one employing encryption, and/or a secure communication channel may be established, such as with a virtual private network (VPN), secure shell (SSH), or other secure technique, protocol, or format.

The first payment agent 220 and the second payment agent 240 may be standalone software programs running on computers at or associated with their respective institutions, or may be implemented as virtual machines (VMs), Software-as-a-Service (SaaS), Platform-as-a-Service (PaaS), or otherwise.

The payer institution 210 and the payee institution 230 as seen in FIG. 2 may represent the respective institutions' computer systems generally, or may be specialized or dedicated subsystems that facilitate or carry out transactions, such as an ACH subsystem. The payer institution 210 and the payee institution 230 may store some or all of the financial records associated with financial institutions, such as account information, account owner information, and the like. The payer institution 210 and the payee institution 230 may be any type of institution engaged in financial transactions, including, without limitation, commercial banks, investment banks, insurance banks, brokerages, investment companies, insurance companies, savings and loans, and credit unions, and may

The first payment agent 220 and the second payment agent 240 may maintain a connection for data communication with the payer institution 210 and the payee institution 230, respectively, or may communicate with the institutions intermittently, either on a schedule or in response to triggering events. For example, the first payment agent 220 may establish a connection with the payer institution 210 upon receipt of the secure payee account information in order to initiate a transaction. In some embodiments, the first payment agent 220 may establish a connection with the payer institution 210 periodically (e.g., hourly, or daily) to initiate any payments for which it has received the secure payee account information from the second payment agent 240 since the last connection.

Similarly, the second payment agent 240 may establish a connection with the payer institution 230 periodically to obtain updated account information for one or more payees. As will be described in more detail below, the second payment agent 240 may maintain a database of tokens, or portions thereof, and the corresponding secure payee account information to be provided to the first payment agent 220 upon request.

In some embodiments, the first payment agent 220 and the second payment agent 240 may not be in direct communication with the payer institution 210 and the payee institution 230, respectively. For example, the secure payee account information received from the second payment agent 240 may be manually retrieved from the first payment agent 220 and provided to the payer institution 210 and/or the payment network 250 directly. In such an embodiment, it may be the first payment agent 220, not the payer institution 210, that initiates the transaction. Similarly, the second payment agent 240 may not need to communicate directly to the payee institution 230; secure payee account information may be retrieved from the payee institution 230 periodically (e.g., daily) and provided to the second payment agent 240 via physical media.

The transaction may be initiated by creating a file in the National Automated Clearinghouse Association (NACHA) format using the payment amount and other details provided by the payer, the payee account information provided by the second payment agent, and other information. In one embodiment, the NACHA file may be generated by the first payment agent 220. The NACHA file may then be provided to the payer institution 210 to be presented to the payment network 250, or may be provided directly to the payment network 250. In another embodiment, the first payment agent 220 simply passes along the secure payee account information it receives from the second payment agent 240 to the payer institution 210, which generates the NACHA file and presents it to the payment network 250.

In response to the transaction being initiated and/or completed, the payer institution 210 and the payee institution 230 may adjust or modify the payer account 212 and the payee account 232, respectively. For example, the payer institution 210 may debit the payer account 212 by the amount of the initiated transaction, and the payee institution 230 may credit the payee account 232 by the amount of the initiated transaction.

Referring to FIG. 3, the first payment agent 220 and the second payment agent 240 may each include a number of elements. Each of the first payment agent 220 and the second payment agent 240 may incorporate a processor 232, 252, respectively, a network interface 222, 242, respectively, and a transaction interface 224, 244, respectively. The processor 232, 252 may be a microprocessor configured to carry out the functions described herein, and may be connected to other system elements by a bus or other interconnection element. The network interface 222, 242 allows the first payment agent 220 and the second payment agent 240 to communicate with each other over a network 270. The network 270 may be a wide-area network (WAN), such as the Internet. In some embodiments, the first payment agent 220 and the second payment agent 240 may be configured to communicate encrypted messages. The first payment agent 220 and the second payment agent 240 may also establish a communication channel 260 over which to communicate via the network 270. In some embodiments, the communication channel 260 may itself employ encryption, and may operate as part of a virtual private network (VPN), secure shell (SSH), or other secure technique, protocol, or format. The transaction interface 224, 244 may be configured to allow the first payment agent 220 and the second payment agent 240 to communicate instructions to the payer institution 210 and the payee institution 230 regarding transactions. For example, the first payment agent 220 may provide the payer institution 210 with the secure payee account information and/or a NACHA file, along with an instruction to carry out a transaction. Similarly, the transaction interface 224, 244 may be used by the first payment agent 220 and the second payment agent 240 to obtain account information from the payer institution 210 and the payee institution 230, respectively. For example, the first payment agent 220 may obtain from the payer institution 210, via the transaction interface 224, information about one or more accounts (e.g., payer account 212) associated with one or more payers. Similarly, the second payment agent 240 may obtain from the payee institution 230, via the transaction interface 244, information about one or more accounts (e.g., payee account 232) associated with one or more payees.

Both the first payment agent 220 and the second payment agent 240 may include other elements that may be relevant depending on whether the first payment agent 220 and/or the second payment agent 240 is associated with a payer or a payee in a given transaction. The following description recites only those elements of the first payment agent 220 relevant to a payer role, and only those elements of the second payment agent 240 relevant to a payee role, though it will be understood that each of the first payment agent 220 and the second payment agent 240 may include those described here in the context of the other agent.

In some embodiments, the first payment agent 220 includes a user interface 226. The user interface 226 is configured to receive a token containing information that identifies, to the second payment agent 240, secure payee account information about one or more accounts, such as payee account 232. The secure payee account information may include the account number or other identifier sufficient to initiate a transaction with the account, as well as routing information or other information about the account and/or the institution. For example, the user interface 226 may be an input device (e.g., a keyboard, touchscreen, and or display device) through which a payer may enter the token, or may be a network or system interface through which the token is received from a network or other system component.

The token is an object that uniquely identifies, to the second payment agent 240, secure payee account information about one or more accounts, but that is not itself actionable for initiating a transaction. For example, someone in possession of the token would not be able to access or modify the payer account 212 or payee account 232. For that reason, the token may be freely published and made publicly accessible. For example, the token may be printed on invoices sent to customers, or may be included on the payee's website, in marketing materials, brochures, packaging, etc. The freely-distributable ACH token may also be passed through third-party systems without concern. For example, payers may be given the option of making a payment by requesting and/or entering the ACH token in an online banking interface or on an ecommerce website.

In some embodiments, the token may be an alphanumeric string, preferably of suitably short length for easy reproduction. In other embodiments, the token may be a longer string or a number, and may consist of any suitable combination of numbers, letters, symbols, or other characters. In still other embodiments, the token may be a complex data structure such as a record or data object.

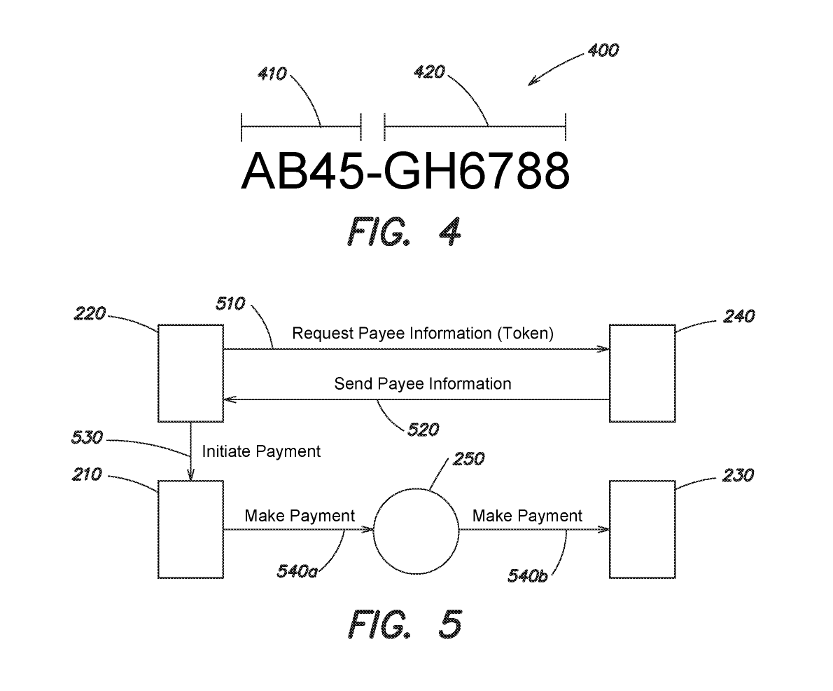

One exemplary alphanumeric token 400 can be seen in FIG. 4. The token contains an account portion 410 and a routing portion 420. Again, the account portion 410 does not identify or reveal the secure payee account information (e.g., payee's account number); rather, the token 400 may be parsed for the account portion 410, which may be used by the second payment agent 240 to lookup the secure payee account information matching the account portion 410. Similarly, the routing portion 420 may be used by the first payment agent 220 to identify a second payment agent 240 to which the request for the secure payee account information should be addressed. For example, the token 400 may be parsed for the routing portion 420, which may be used by the first payment agent 220 to lookup an identifier (e.g., a name, network address, or bank routing number) of the second payment agent 240 associated with the routing portion 420.

The account portion 410 of the token 400 may uniquely identify a payee account on a group of any number of other payment agents (i.e., it is universally unique). In another embodiment, the account portion 410 may identify a payee account only on a particular payment agent. For example, the same account portion 410 may identify one payee account on one payment agent, and identify another payee account on another payment agent.

Other information may also be stored in, or represented by, the token. In one embodiment, a portion of the token may represent a channel through which the token was distributed. For example, the token may indicate that it was obtained from a billboard on which it was displayed, providing valuable tracking and insight into how tokens are encountered and obtained by users. As another example, a portion of the token may represent a promotional code offering a discount, free shipping, or other benefit to a user who uses the token to make a payment.

Returning to FIG. 3, the first payment agent 220 may include a payment agent database 230 that includes identifying or access information for one or more payment agents (e.g., second payment agent 240). The payment agent database 230 may associate one or more tokens or portions thereof (e.g., routing portion 420) with an identifier (e.g., a name, network address, or bank routing number) with one or more payment agents (e.g., second payment agent 240). Continuing the previous example, the payment agent database 230 may associate the routing portion 420 “GH6788” with an identifier of a particular second payment agent 240. The information in the payment agent database 230 may be provided by an external entity (such as a controller for the first payment agent 220 and/or the second payment agent 240, or the payer institution 210), or may be determined by the first payment agent 220 periodically polling the second payment agent 240, or by the second payment agent 240 periodically provided the first payment agent 220 with an identifier and the associated token or portion thereof. The first payment agent 220 may also incorporate a payer database 228, which may include information about one or more payer accounts 212 at the payer institution 210. Such account information may be used in generating a NACHA file, for example.

The second payment agent 240 may further comprise a payee database 248, which stores the secure payee account information in association with the token or a portion thereof (e.g., the account portion 410). Upon receiving a token from the first payment agent 220, the second payment agent 240 may use the token to refer to the payee database 248 and retrieve the corresponding secure payee account information.

The payer database 228, payment agent database 230, and/or the payee database 248 may take the form of any logical construction capable of storing information on a computer readable medium including flat files, indexed files, hierarchical databases, relational databases and/or object oriented databases. The data may be modeled using unique and foreign key relationships and indexes. The unique and foreign key relationships and indexes may be established between the various fields and tables to ensure both data integrity and retrieval speed.

Information may flow within and between the components of system 200 using any technique known in the art. Such techniques include passing the information over the network via TCP/IP, passing the information between modules in memory, and passing the information by writing to a file, database, or some other non-volatile storage device.

With reference to FIG. 5, an exemplary flow 500 of data between the first payment agent 220, the second payment agent 240, the payer institution 210, and the payee institution 230 will now be described. At step 510, the first payment agent 220 passes the token to the second payment agent 240 and requests the secure payee account information associated with the token. At step 520. the second payment agent 520 transmits, to the first payment agent 220, the secure payee account information. At step 530, the first payment agent 220 instructs the payer institution 210 to initiate a payment, using the secure payee information, to the payee account at the payee institution 230. At steps 540a,b, the payer institution 210 makes the payment from the payer account to the payee account at the payee institution 230 via the payment network 250.

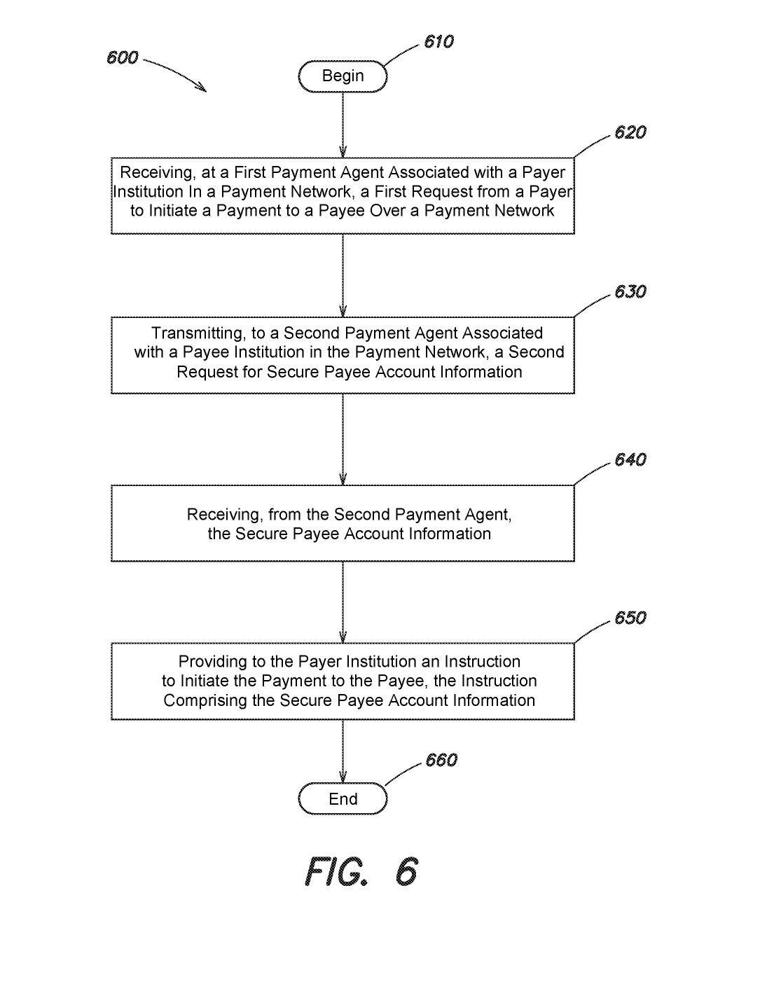

With reference to FIG. 6, an exemplary process 600 from the perspective of a first payment agent (e.g., first payment agent 220) associated with a payer institution will now be described.

At step 610, process 600 begins.

At step 620, the first payment agent receives a request from a payer to initiate a payment to a payee over a payment network. The request may be provided directly by the payer to the first payment agent, such as through a graphical user interface provided by the first payment agent. The request may include a token as described herein, a payment amount, a payment date/time, payer information, payer account information, a memorandum to accompany the payment, or other information. For example, the user may type the token and the other information into a graphical user interface. In another example, the payer may submit the request through a different system or interface, such as an online banking or ecommerce website. The request may then be provided to the first payment agent via a system or network interface.

At step 630, the first payment agent transmits, to a second payment agent associated with a payee institution in the payment network, the request for secure payee account information. The request for secure payee account information may include the token, portions thereof, or information determined by the first payment agent from the token. In one example, the entire token may be sent to the second payment agent. In another example, the first payment agent may send only information identifying the payee. For example, the first payment agent may parse the token to determine both an identifier of the second payment agent (e.g., a routing number) and the identifier of the payee, and, once the second payment agent has been identified, may send only the portion of the token identifying the payee to the second payment agent.

The request for secure payee account information may be sent via a network (e.g., the Internet, or a WAN), and may be encrypted and/or sent via a secure channel or protocol, such as virtual private network (VPN), secure shell (SSH), or other secure technique, protocol, or format.

Upon receiving the request for the secure payee account information, the second payment agent may determine if the request and/or the first payment agent are legitimate and/or authorized to make such a request. For example, the second payment agent may parse the request (e.g., the token or a portion thereof) to determine if it is legitimate. The second payment agent compares the request to a database of known payee identifiers recognized in tokens to determine if the request corresponds to an existing payee account for which the second payment agent has information it is authorized to provide. If so, the request may be honored, and the second payment agent may transmit the secure payee account information to the first payment agent.

In some embodiments, additional checking may be performed before the secure payee account information is transmitted to the first payment agent. For example, the identity of the first payment agent, and its authority to request the secure payee account information, may be verified by the second payment agent with reference to a database of payment agents. In another example, the request may be examined to confirm that it is correctly formed. For example, a token included in the request may be evaluated for its format, and any checks or policies (e.g., a checksum of one or more digits in the token) may be performed.

At step 640, the first payment agent receives, from the second payment agent, the secure payee account information. Any necessary decryption or unpacking of the information may be performed on the received information. The secure payee account information, such as the payee account number or other account identifier, and the payee routing number, are obtained.

At step 650, the first payment agent provides to the payer institution an instruction to initiate the payment to the payee, the instruction comprising the secure payee account information. The transaction may be initiated by creating a file in the NACHA format using the payment amount and other details provided by the payer, the payee account information provided by the second payment agent, and other information. In one embodiment, the NACHA file may be generated by the first payment agent. The NACHA file may then be provided to the payer institution to be presented to the payment network, or may be provided directly to the payment network. In another embodiment, the first payment agent simply passes along the secure payee account information it receives from the second payment agent to the payer institution, which generates the NACHA file and presents it to the payment network.

At step 660, process 600 ends.

It will be appreciated that the present aspects are not limited to the examples discussed here. For example, while the examples provided are in the context of an ACH network, the present embodiments may also be applied to other payment networks, such as the Federal Reserve Wire Network (Fedwire) offered by the United States Federal Reserve Banks, the Paypal service offered by PayPal Holdings, Inc. (San Jose, Calif.), or other online payment service providers. It will also be appreciated that the present embodiments may be applied to non-traditional currency such as purchased credits, Bitcoins, or the like.

Exemplary Computer System

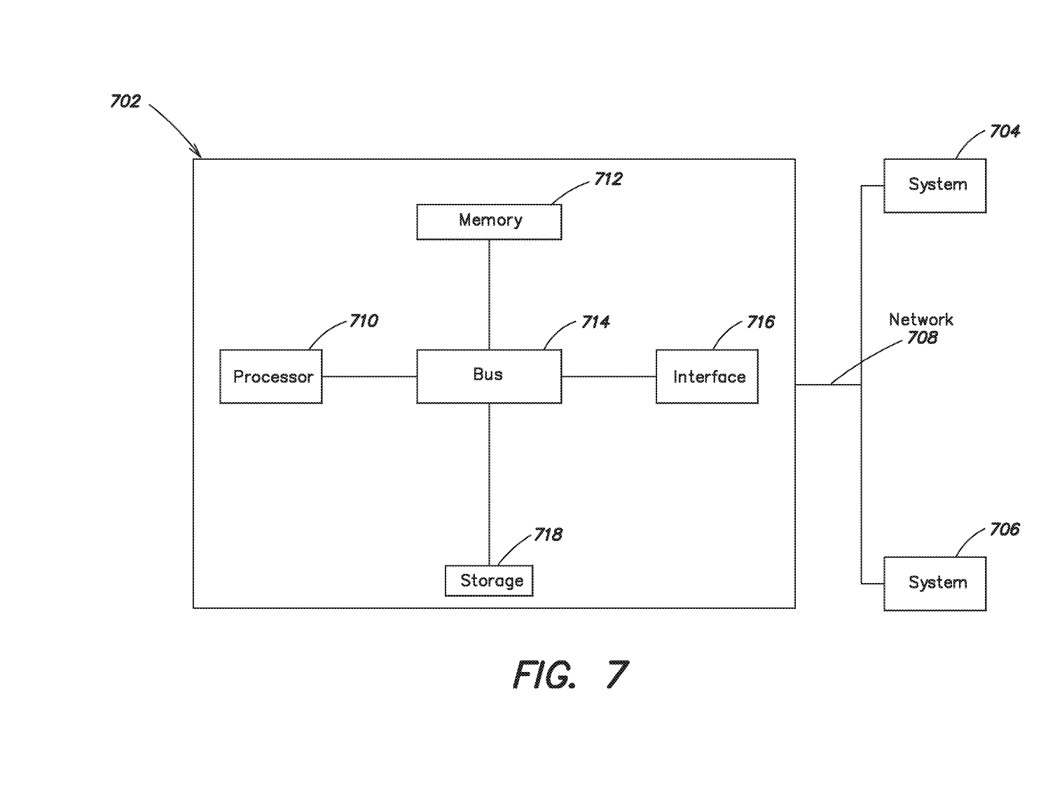

FIG. 7 is a block diagram of a distributed computer system 700, in which various aspects and functions discussed above may be practiced. The distributed computer system 700 may include one or more computer systems. For example, as illustrated, the distributed computer system 700 includes three computer systems 702, 704 and 706. As shown, the computer systems 702, 704 and 706 are interconnected by, and may exchange data through, a communication network 708. The network 708 may include any communication network through which computer systems may exchange data. To exchange data via the network 708, the computer systems 702, 704, and 706 and the network 708 may use various methods, protocols and standards including, among others, token ring, Ethernet, Wireless Ethernet, Bluetooth, radio signaling, infra-red signaling, TCP/IP, UDP, HTTP, FTP, SNMP, SMS, MMS, SS7, JSON, XML, REST, SOAP, CORBA HOP, RMI, DCOM and Web Services.

According to some embodiments, the functions and operations discussed for producing a three-dimensional synthetic viewpoint can be executed on computer systems 702, 704 and 706 individually and/or in combination. For example, the computer systems 702, 704, and 706 support, for example, participation in a collaborative network. In one alternative, a single computer system (e.g., 702) can generate the three-dimensional synthetic viewpoint. The computer systems 702, 704 and 706 may include personal computing devices such as cellular telephones, smart phones, tablets, “fablets,” etc., and may also include desktop computers, laptop computers, etc.

Various aspects and functions in accord with embodiments discussed herein may be implemented as specialized hardware or software executing in one or more computer systems including the computer system shown in FIG. 7. In one embodiment, computer system 702 is a personal computing device specially configured to execute the processes and/or operations discussed above. As depicted, the computer system 702 includes at least one processor 710 (e.g., a single core or a multi-core processor), a memory 712, a bus 714, input/output interfaces (e.g., 716) and storage 718. The processor 710, which may include one or more microprocessors or other types of controllers, can perform a series of instructions that manipulate data. As shown, the processor 710 is connected to other system components, including a memory 712, by an interconnection element (e.g., the bus 714).

The memory 712 and/or storage 718 may be used for storing programs and data during operation of the computer system 702. For example, the memory 712 may be a relatively high performance, volatile, random access memory such as a dynamic random access memory (DRAM) or static memory (SRAM). In addition, the memory 712 may include any device for storing data, such as a disk drive or other non-volatile storage device, such as flash memory, solid state, or phase-change memory (PCM). In further embodiments, the functions and operations discussed with respect to generating and/or rendering synthetic three-dimensional views can be embodied in an application that is executed on the computer system 702 from the memory 712 and/or the storage 718. For example, the application can be made available through an “app store” for download and/or purchase. Once installed or made available for execution, computer system 702 can be specially configured to execute the functions associated with producing synthetic three-dimensional views.

Computer system 702 also includes one or more interfaces 716 such as input devices (e.g., camera for capturing images), output devices and combination input/output devices. The interfaces 716 may receive input, provide output, or both. The storage 718 may include a computer-readable and computer-writeable nonvolatile storage medium in which instructions are stored that define a program to be executed by the processor. The storage system 718 also may include information that is recorded, on or in, the medium, and this information may be processed by the application. A medium that can be used with various embodiments may include, for example, optical disk, magnetic disk or flash memory, SSD, among others. Further, aspects and embodiments are not to a particular memory system or storage system.

In some embodiments, the computer system 702 may include an operating system that manages at least a portion of the hardware components (e.g., input/output devices, touch screens, cameras, etc.) included in computer system 702. One or more processors or controllers, such as processor 710, may execute an operating system which may be, among others, a Windows-based operating system (e.g., Windows NT, ME, XP, Vista, 7, 8, or RT) available from the Microsoft Corporation, an operating system available from Apple Computer (e.g., MAC OS, including System X), one of many Linux-based operating system distributions (for example, the Enterprise Linux operating system available from Red Hat Inc.), a Solaris operating system available from Oracle Corporation, or a UNIX operating systems available from various sources. Many other operating systems may be used, including operating systems designed for personal computing devices (e.g., iOS, Android, etc.) and embodiments are not limited to any particular operating system.

The processor and operating system together define a computing platform on which applications (e.g., “apps” available from an “app store”) may be executed. Additionally, various functions for generating and manipulating images may be implemented in a non-programmed environment (for example, documents created in HTML, XML or other format that, when viewed in a window of a browser program, render aspects of a graphical-user interface or perform other functions). Further, various embodiments in accord with aspects of the present invention may be implemented as programmed or non-programmed components, or any combination thereof. Various embodiments may be implemented in part as MATLAB functions, scripts, and/or batch jobs. Thus, the invention is not limited to a specific programming language and any suitable programming language could also be used.

Although the computer system 702 is shown by way of example as one type of computer system upon which various functions for producing three-dimensional synthetic views may be practiced, aspects and embodiments are not limited to being implemented on the computer system shown in FIG. 7. Various aspects and functions may be practiced on one or more computers or similar devices having different architectures or components than that shown in FIG. 7.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. An electronic clearinghouse system comprising:
a first payment agent associated with a payer institution and configured to transmit a request for secure payee account information, and further configured to initiate a payment over a payment network from the payer institution to a payee using the secure payee account information; and
a second payment agent associated with a payee institution that is associated with the payee identified by the secure payee account information, the second payment agent configured to receive, from the first payment agent, the request for the secure payee account information, and further configured to transmit the secure payee account information to the first payment agent.

2. The system of claim 1, wherein the request includes a token identifying at least one of the payee and the payee institution.

3. The system of claim 2, wherein the first payment agent is further configured to identify, from the token, the second payment agent from a plurality of second payment agents, and to transmit the request for the secure payee account information to the second payment agent.

4. The system of claim 2, wherein the token includes a payee identifier, and wherein the second payment agent further comprises a payee database that associates the payee identifier with the secure payee account information.

5. The system of claim 1, wherein the payment network is an automated clearinghouse (ACH) network.

6. The system of claim 5, wherein the first payment agent is further configured to:
generate, based on the secure payee account information, a file in a national automated clearinghouse association (NACHA) file format; and
provide the file to the payer institution.

7. The system of claim 1, wherein the first payment agent is executed on a first server, and wherein the second payment agent is executed on a second server, wherein the first server and the second server are configured to communicate via a secure communication channel.

8. The system of claim 1, wherein the second payment agent is configured to transmit the secure payee account information to the first payment agent responsive to determining that the first payment agent is authorized to receive the secure payee account information.

9. The system of claim 1, wherein each of the first payment agent and the second payment agent further comprises a network interface in communication with a network through which the first payment agent and the second payment agent are communicatively coupled.

10. The system of claim 9, wherein the network is a peer-to-peer network over which the first payment agent and the second payment agent are configured to communicate with each other.

11. The system of claim 1, wherein the first payment agent further comprises a transaction interface, and wherein the first payment agent is further configured to initiate the payment via the transaction interface using the secure payee account information.

12. A method of processing payments comprising:
receiving, at a first payment agent associated with a payer institution in a payment network, a first request from a payer to initiate a payment to a payee over the payment network;
transmitting, to a second payment agent associated with a payee institution in the payment network, a second request for secure payee account information;
receiving, from the second payment agent, the secure payee account information; and
providing to the payer institution an instruction to initiate the payment to the payee, the instruction comprising the secure payee account information.

13. The method of claim 12, wherein the first request includes a token comprising at least one of a payee identifier and a payee institution identifier.

14. The method of claim 12, wherein the secure payee account information comprises an account number of the payee at the payee institution.

15. The method of claim 12, wherein the secure payee account information comprises a routing number of the payee institution.

16. The method of claim 12, wherein the payment network is an automated clearinghouse (ACH) network.

17. The method of claim 16, wherein the instruction to initiate the payment to the payee comprises an instruction to perform an ACH push.

18. The method of claim 16, further comprising:
generating by the first payment agent, based on the secure payee account information, a file in a national automated clearinghouse association (NACHA) file format; and
transmitting the file to the payer institution.

19. The method of claim 12, wherein the first request includes a payment amount.

20. The method of claim 12, wherein the first payment agent and the second payment agent are configured to communicate via a peer-to-peer network.

21. The method of claim 12, wherein the first payment agent is further configured to identify, from the request, the second payment agent from a plurality of second payment agents.
